(19) United States
(12) Patent Application Publication
(10) Pub. No.: US 2004/0215515 A1
(43) Pub. Date: Oct. 28, 2004

(54) Method of distributing targeted Internet advertisements based on search terms

(75) Inventor: Morgan Perry, Brier, WA (US)

Correspondence Address: LANGLOTZ PATENT WORKS, INC., PO BOX 759, GENOA, NV, 89411, US

(73) Assignee: aQuantive, Inc.

(21) Appl. No.: 10/759,553

(22) Filed: Jan. 16, 2004

Related U.S. Application Data
(63) Continuation-in-part of application No. 10/423,512, filed on Apr. 25, 2003.

(51) Int. Cl. G06F 17/60; G06F 7/00; G06F 17/00

(52) U.S. Cl. 705/14; 707/104.1

(57) ABSTRACT

A method of distributing Internet advertisements includes collecting search terms employed by users of a search engine or search provider or its distribution partners web site(s), and collecting a unique identifier or cookie associated with each user. The search terms and unique identifiers are associatively stored in a database. A number of selected advertising strategies are generated, each having an associated desired search term or set of terms. Identifiers associated with one or more of the desired search terms are assigned to an associated one of the advertising strategies. In response to a user visiting a publisher web site, the user's unique identifier is determined, the database is searched to determine an assigned advertising strategy, and an advertisement is served to the user based on the strategy. Users not fitting any assigned advertising strategy may or may not receive an advertisement.

### REFERENCE TO RELATED APPLICATION

This is a Continuation-in Part of U.S. patent application Ser. No. 10/423,512 filed Apr. 25, 2003, and entitled Method of Distributing Targeted Internet Advertisements.

### FIELD OF THE INVENTION

This invention relates to Internet communication, and more particularly to the distribution of advertisements.

### BACKGROUND AND SUMMARY OF THE INVENTION

The Internet is an effective tool for commercial communication. Companies electronically communicate with consumers to cost-effectively promote their goods or services. Normally, an Advertising Service Company (ASC) contracts with web publishers who have advertising placement space (such as banner ads), and with advertisers, such as Internet retailers. For example, a user browsing the Internet World Wide Web may click on a banner ad, which will lead the user to the advertiser's retail website. This is known as third-party ad-serving, and is one environment in which the preferred embodiment of the invention may operate.

When a user visits a website, a unique identifier (e.g., cookie) associated with the computer or other device employed by the user is written to the user's computer hard drive by the Advertising Service Company, and information about the visit is stored in the company's database. The recorded information may include logging the interaction with the user's cookie anytime he/she views an advertisement, clicks an advertisement, or visits a page on an advertiser's site, where an “action tag” is loaded to capture the interaction. The cookie interactions are used to tie transactions on the advertiser's site to interactions (views and clicks) with advertisements. The cookie interaction is logged whenever an impression of an advertisement is served, whenever a user clicks on the advertisement, or whenever the user undertakes any of a wide variety of actions including page views, commercial transactions, provision of information such as an email address for future communications, and any other activity desired by the advertiser. For purposes of this discussion, all of these activities are considered to be “actions,” as contrasted with “impressions” of advertisements served.

In conventional Internet advertising approaches, advertisements are served by placement. Advertisers (or the service companies that assist and represent them) must determine which web sites, publishers, and placements provide the best-suited demographic, psychographic, or behavioral segment to reach with advertisements. Of course, as with any broadcast form of advertising, many of those who receive the advertisement will not be of the desired demographic, psychographic, or behavioral segment. Nonetheless, even slight differences among sites is enough to lead an advertiser to prefer one site over another. A problem with this approach is that pricing is based on the number of ads served, even if served to those who are not likely to respond positively to the ads.

Another problem is that users face advertisements that are of no interest, are distracting, and convey no relevant information, making the Internet relatively less appealing than other forms of information gathering, entertainment, or shopping. When a user receives an ad that is of interest, his browsing experience is enhanced, and he is more likely to return to the publisher's site in the future. Thus, publishers are more interested in offering advertising space to advertisers their visitors most value (or least object to, or find most relevant).

Even with the best available information about a web site's demographics, advertisements must be displayed to many users unlikely to respond, in order to reach a user of a demographic, psychographic, or behavioral segment likely to respond. Bulk email transmissions provide a much more targeted approach, but with significant disadvantages. A list of known prospects (such as the group of people who subscribe to a particular magazine, or who have purchased particular goods) can form the basis for a targeted email solicitation. While effective in some circumstances, these have several disadvantages. Commercial emails may be filtered by the recipients' software, received messages may be viewed as a distraction when they arrive at the wrong time of day, and excess commercial email may be generally unwanted by many users.

Other systems may use databases of information that associate user cookies with other information that helps to establish which users are the best prospects for particular advertisements. A problem with these and related systems is that only a minor fraction of users are associated with useful information. Thus, even though a particular advertisement might be served to all users whose cookies are associated with membership in a particular organization, or subscription to a particular magazine, such users are probably only a small minority of all of those to visit a given publisher's site. Accordingly, even if an advertiser would be willing to pay a premium to reach those users with a given advertisement, the cost of the advertisement would be expensive because even the users not in the desired demographic, psychographic, or behavioral segment would need to be served advertisements. Even if the advertiser arranged only to serve a targeted advertisement to the particular selected users, and the remaining visitors were served a different advertisement in the same place, the small number of targeted advertisements served (even at a higher price per ad) would likely be so small (perhaps only 5% or less) that the transaction would be of little interest to the publisher.

In addition, publishers would be understandably reluctant to have advertising served only to selected visitors, because this would leave blank space in the ad placement space (or random ads or other filler material.) To provide enough revenue, the publisher would need to devote a larger portion of a web page to advertisements, which would reduce desired content.

Even when such issues are not a concern, and a publisher is willing to devote advertisement space on the page to a campaign, there are limitations to the sources of information that can be employed to determine the optimum advertisement to serve to a user. Many of the visitors to a publisher website are not in the available databases that provide important customer information, and these users may still be highly desired by particular advertisers who are as yet unaware of the user's pertinent characteristics and interests

The present invention overcomes the limitations of the prior art by providing a method of distributing Internet advertisements. The method includes collecting search terms employed by users of a search engine web site, and collecting a unique identifier or cookie associated with each user. The search terms and unique identifiers are associatively stored in a database. A number of selected advertising strategies is generated, some or all having an associated desired search term or set of terms. Identifiers associated with one of the desired search terms are assigned to one or more of the advertising strategies. In response to a user visiting a publisher web site, the user's unique identifier is determined, the database is searched to determine an assigned advertising strategy, and an advertisement is served to the user based on the strategy.

### BRIEF DESCRIPTION OF THE DRAWINGS

FIG. 1 is a schematic block diagram showing the system and environment in which a preferred embodiment of the invention operates.

FIG. 2 is a flow chart illustrating operation of the invention.

FIG. 3 is a flow chart illustrating operation of an alternative embodiment of the invention.

### DETAILED DESCRIPTION OF A PREFERRED EMBODIMENT

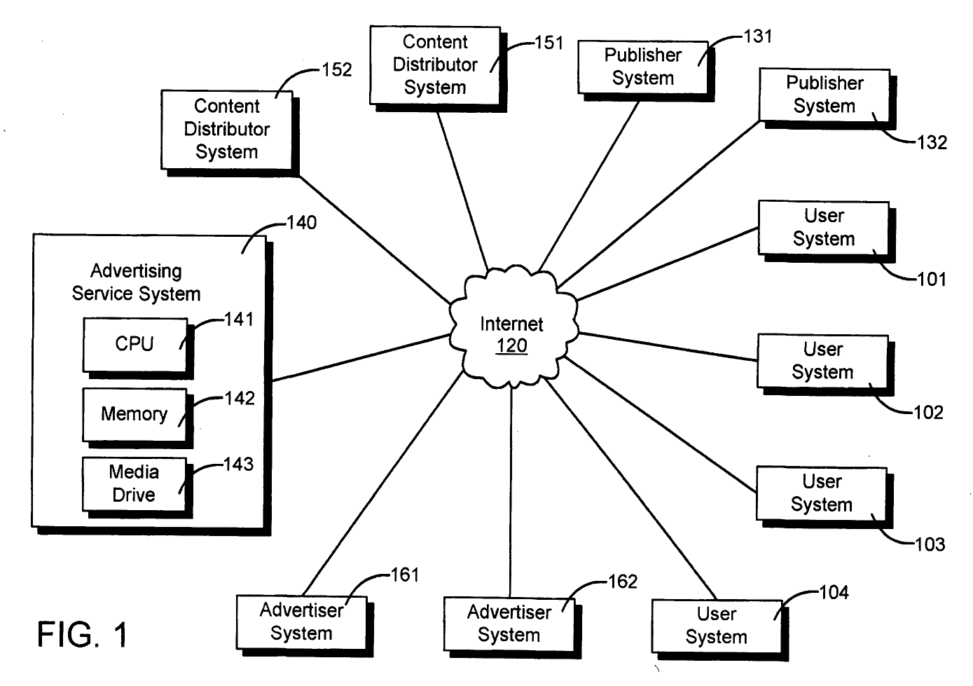

FIG. 1 is a high-level block diagram showing the environment in which the facility preferably operates. The diagram shows a number of Internet customer or user computer systems 101-104. An Internet customer preferably uses one such Internet customer computer system to connect, via the Internet 120, to an Internet publisher computer system, such as Internet publisher computer systems 131 and 132, to retrieve and display a Web page. This is generally referred to “web browsing,” and may include non-commercial activity as well as commercial activity such as retail purchases. An Advertising Service Company (ASC) 140 (or third-party ad server), advertisers 161, 162, and content distributors 151, 152 communicate via the Internet to serve advertisements placed on publisher web sites to users visiting those sites, in the manner discussed below.

Although discussed in terms of the Internet, this disclosure and the claims that follow use the term “Internet” to include not just personal computers, but all other electronic devices having the capability to interface with the Internet or other computer networks, including portable computers, telephones, televisions, appliances, electronic kiosks, and personal data assistants, whether connected by telephone, cable, optical means, or other wired or wireless modes including but not limited to cellular, satellite, and other long and short range modes for communication over long distances or within limited areas and facilities.

In cases where an Internet advertiser, through the ASC, has purchased advertising space on one of several Web pages provided to the Internet customer computer system by one of the Internet publisher computer systems, the Web page contains code calling for information or images (e.g., an advertisement) in the domain of the Internet advertising service company computer system 140. (In the preferred embodiment discussed below, the advertiser does not select a specific space, but grants the ASC the power to control which publishers' sites will generate the greatest desired effect.) When a customer computer system receives a Web page that contains such a reference, the Internet customer computer systems sends a request to the ASC computer system to return data comprising an advertising message, such as a banner advertising message.

When the ASC computer system receives such a request, it selects an advertising message to transmit to the Internet customer computer system in response the request, and either itself transmits the selected advertising message or redirects the request containing an identification of the selected advertising message to an Internet content distributor computer system, such as Internet content distributor computer systems 151 and 152.

When the Internet customer computer system receives the selected advertising message, the Internet customer computer system displays it within the Web page. The Internet advertising service is not limited to banner advertisements, which are used as an example. Other Internet advertising modes include email messages directed to a user who has provided his or her email address in a request for such messages. Alternatively, instead of the third-party ad-serving model discussed above, the preferred embodiment may operate without an ASC, with the publisher serving its own ads and performing the actions that are normally performed by the ASC in the third-party model.

The displayed advertising message preferably includes one or more links to Web pages of the pertinent Internet advertiser's Web site. When the Internet customer selects or “clicks” one of these links in the advertising message, the Internet customer computer system uses the link to retrieve the Web page from the appropriate Internet advertiser computer system, such as Internet advertiser computer system 161 or 162. In visiting the Internet advertiser's Web site, the Internet customer may traverse several pages, and may take such actions as purchasing an item or bidding in an auction.

The Internet advertising service company computer system 140 preferably includes one or more central processing units (CPUs) 141 for executing computer programs such as the facility, a computer memory 142 for storing programs and data, and a computer-readable media drive 143, such as a CD-ROM drive, for reading programs and data stored on a computer-readable medium.

While preferred embodiments are described in terms of the environment described above, those skilled in the art will appreciate that the facility may be implemented in a variety of other environments, including a single, monolithic computer system, as well as various other combinations of computer systems or similar devices.

The preferred embodiment of the invention operates to serve pop-up or other unembedded ads only to selected visitors to a web page who are identified as being members of a target list.

Unembedded ads are distinguished from conventional banner ads that hold a reserved placement location on a web page, and include pop-ups and pop-unders, in which a new browser window containing the ad is opened, as well as floating ads, employing dynamic html, which temporarily overlay the page content. The term “pop-up” is used herein as a general term intended to encompass all unembedded advertisement types. An alternative embodiment involves the same approach with banner placements being served only if the user matches a key segment list held by the ASC. If not, the alternative embodiment returns the ad request to the publisher site to be fulfilled by the publisher or its agent(s). The system operates over any number of publisher web sites, and serves any number of advertisements from any number of advertisers. The additional embodiment below may also serve such unembedded ads, or may be employed advantageously for serving of conventional ads.

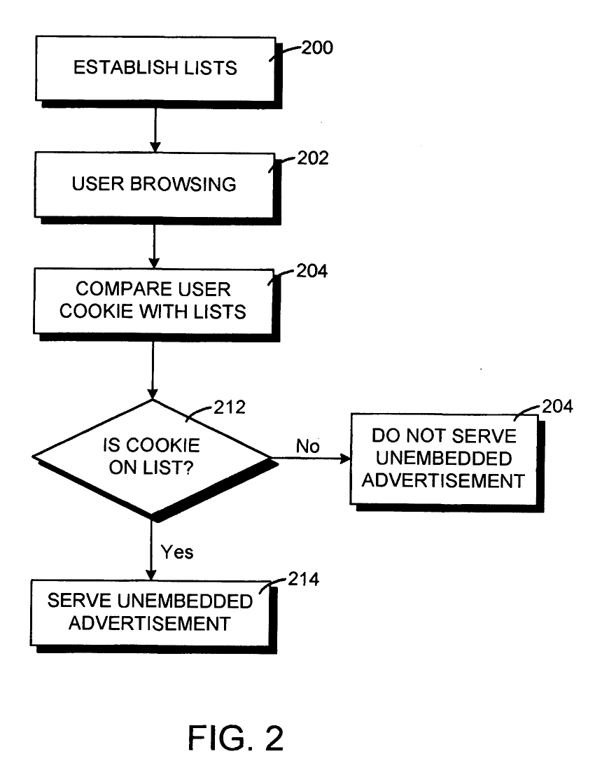

As shown in FIG. 2, the preferred embodiment operates by the generation or establishment of databases or lists of user cookies (i.e. unique device identifiers) in step 200. Each list corresponds to a group of selected users who are to be targeted by a given advertisement or advertising campaign. In the preferred embodiment, the ASC collects the lists, so that ads from the advertisers may be served on the various web sites at which the ASC has arranged on behalf of the advertisers to purchase advertising display services. The lists may originate from any source. In the additional embodiment below, a specific additional source is disclosed based search terms employed by users of Internet search engines.

In step 202, a user visits a web page of a publisher that has arranged with the ASC for the preferred embodiment service. A code on the page is. served to the user, and causes the user's computer to communicate with the ASC, in the manner of conventional Internet advertisement service. In the process, the ASC determines a unique identifier (cookie) associated with the user's computer or other browsing device. In step 204, the ASC searches the lists in real time to determine (in step 206) if the cookie is on any of the lists. If the cookie is on a list, the ASC serves an unembedded advertisement associated with that list to the user in step 208. The served advertisement does not occupy the page that the user was seeking, and thus the sought page is displayed in the same form whether or not the user was on a list (although a dynamic html message may overlay the page). Alternatively, if the ad placement is an embedded placement and the cookie is not on a list, the ad request is returned to the publisher to fulfill or in some other manner fulfilled with ads due to other arrangements.

If the user is on more than one list, there are several alternatives. The user may be served an ad associated with the first list entry, so that the ad is served quickly, and further searching is not needed. In this approach, the order in which lists are searched could be rotated or randomized to avoid bias in favor one any one particular list. Alternatively, when a user is on multiple lists, the ad to be served may be selected at random or by rotation (on subsequent visits to any affiliated publisher's site, and user would receive a different advertisement.) Alternatively, the user may receive multiple pop-ups (or other unembedded ads), because multiple windows can be opened at once, so that the user receives all pertinent ads of interest. Alternatively, the ad served could be won or lost through a bid system in which the advertiser that was willing to pay most for messaging to a list won all or most of the list.

If the user is not on any list, the publisher's page is displayed normally, with no unembedded advertisements, as in step 210, or with an embedded ad request returned to the publisher and fulfilled through the publisher or its agent(s). Unembedded ads that would have been served due to other arrangements may be served, but no unembedded ads are served on behalf of the ASC and/or its advertiser clients.

The system has the advantage of not serving advertisements to those who are unlikely prospects. Thus, each ad service is much more valuable to the advertiser. This works toward the goal of offering each user only relevant advertisements, and is a way to efficiently reach a niche audience.

Because any one list/advertisement may apply to only a small fraction of users, perhaps well less than 1%, there is an important advantage in the ASC accumulating different advertisers and advertisements, to aggregate the targeted audience to a more significant percentage of the total number of users who visit a given site. This aggregate amount may still be a minor percentage of user site visits, and there is thus an advantage to having the ASC conducting the process. This advantage flows from the fact that the ASC may be serving conventional advertisements for the various publishers under conventional terms. The service of an occasional high value pop-up advertisement to the user who is on a target list is essentially “icing” on the “cake” that justifies the arrangements between the ASC and publishers as well as being a strong inducement for more advertisers to take advantage of the targeting capabilities being offered through the site. Similarly, the ASC may arrange with advertisers for conventional advertising service, and offer the targeted pop-up ads as an additional service.

Even though the majority of users may not receive advertisements under this system, no party is any worse off, because the publisher did not need to reserve advertising space on its page, which would then go blank or be filled by a low-value message. The unlisted user simply does not receive a pop-up ad and/or receives an ad placement provided by other arrangements.

In the case of the ad not being served, the request may or may not be returned to the publisher for placement of an ad by the publisher or its agent(s).

In an alternate embodiment, the advertisement may be an embedded placement, such as the common 468×60 banner placement (“banner” will hereinafter refer to any and all embedded placements including, but not limited to standard Internet Advertising Bureau ad units such as 468×60s, 234×60s, 120×90s, 120×60s, 120×600s, 728×90s, 125×125s and 250×250s). In such an embodiment, the act of not serving an ad is associated with returning the initial ad request to the publisher for the publisher or its agent(s) to fill the embedded placement.

This system and method is particularly well-suited for business-to-business transactions.

For instance, industrial purchasing agents might be a very low percentage of Internet users, and conventional ads for industrial goods would be wasted on the vast majority of users. However, the service of a single ad to such an agent would be much more valuable than an ad that needlessly reaches a multitude of typical Internet users, especially since such an agent may have the means to avoid commercial emails.

To avoid inundating targeted individuals with pop-up or other ads every time they visit publishers with such arrangements, the frequency of service can be controlled by day, site, and campaign. This prevents the user from receiving more than a certain number of ads per time period, or site, and avoids over-saturating the user with ads from a single campaign. By recording which ads are served to which users to ensure this control, other features may be provided, such as sequencing different advertisements in a single campaign.

The system may also employ novel arrangements for obtaining and financing the lists. For instance, the original list owner (such as a magazine publisher) may be offered the opportunity to profit from use of the list, by receiving a share of the revenue generated by the process.

### Additional Preferred Embodiment

An alternative or enhanced method of operation of operation uses data gathered from the Internet web and other types of searches conducted by users of any type of search facility.

These include primary search engines having their own well-known websites such as Google and Yahoo!, as well as search engines and services that provide services to other publisher websites desiring to provide search functionality to their own sites. Alternate search facilities may be provided via digital TV, cell phones, PDAs, and other electronic or communication devices that access the Internet or other information sources.

A user conducting a search typically submits a search with one or more terms or words. For purposes of this disclosure, a term may be a single word, or a combination of words.

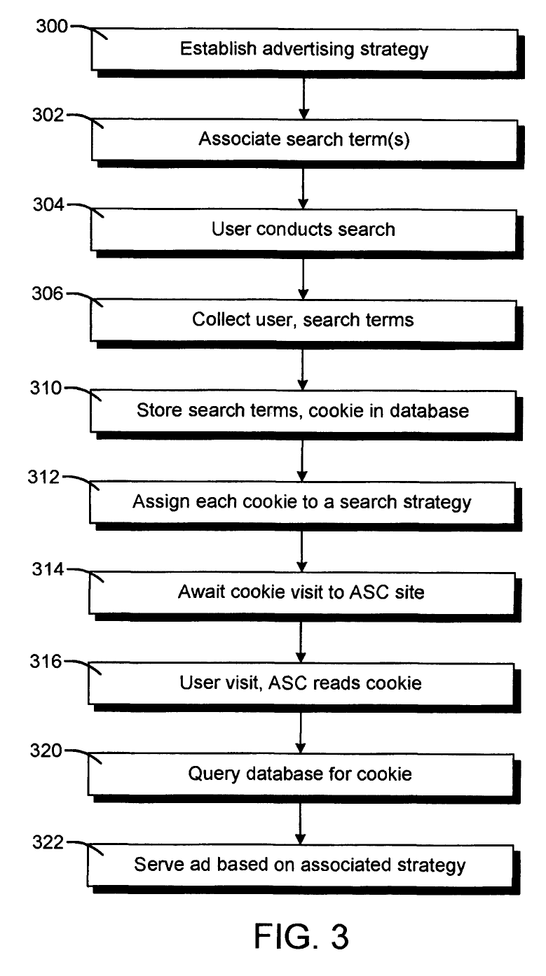

In this approach, the Advertising Service Company (ASC) contracts with Advertisers, with or for each of whom one of more advertising strategies is established, as indicated in step 300 of FIG. 3. Establishment of an advertising strategy may be nothing more than creating or selecting a single advertisement. Alternative strategies are unlimited, and may include any Internet advertising approach, including the ad types noted above, in any combination or sequence. An advertising strategy is simply a campaign or process designed for a selected subset of users.

In step 302, a set of one or more search terms is selected. These are the search terms that the advertiser and its advisors have determined that users in the selected desired subset are likely to employ. Put another way, users who use these terms are in the desired subset. For instance, an advertiser that retails home electronics might highly value the ability to serve ads to those users who searched specific search terms, e.g., “home theater” or “plasma television,” so that ads can be served to such users for pertinent products. In practice, the definitions of pertinent search terms is likely to be a much more complex Boolean search string, such as:

[home and (theater or theatre)] or hdtv or (high and definition) or plasma or (big and screen) or . . .

Because a search string is associated with an advertising strategy does not mean that the entire string must be matched by a user's search query; the query merely must meet the logical requirements of the string, e.g., the user may have entered “home theatre system from Sony” but the ASC might add this to a user list for “home theatre”. The intention is that the text body of each string (or the aggregate of all a user's search queries) is searched to see if it meets the Boolean request. This is analogous to the body of Internet content searched by a user, except that the user's string will be the body of content, as will be discussed below.

In step 304, one of many individual uses of a search engine occurs. By submitting the search, the user triggers the search engine to return its results in a results page. The results page includes an “extended data action tag” that is ASC code (e.g., a one pixel image that is not visible to the user). To display the page, the user's web browser automatically triggers the ASC code (e.g., to retrieve the pixel associated with the action tag). This code calls to an ASC server that queries the user's computer for a unique identifier or cookie. Normally, the cookie has already been provided to the user's computer by the ASC on serving a prior ad, but on a first visit by a new computer or browser, the ASC assigns a cookie.

In step 306, the ASC collects the cookie, as well as recording the search terms through the ASC code placed with the search provider. The search terms may be recorded in conjunction with the action tag, with the tag having data fields not only for the cookie, but also to capture and record the search terms. In step 310, the search terms and cookie are stored in a database on an ASC server. The search terms are associated with the cookie in one or more records of the database. Each cookie could be associated with one or more search terms. The database may simply include a growing list of terms, providing a text body for each cookie. Preferably, however, the contents of each search string are associated with each other, each string being treated as a single search term. These terms can be ranked for list generation and use according to a variety of marketing rationales, such as recency, frequency or monetary value.

Steps 300 and 302 may follow the creation of the database, as new advertisers begin using the method, employing the accumulated database of user searches. Generally, criteria may be established to limit the process to user search terms that were employed within a limited recent time interval to avoid stale interests. This may differ for different ad strategies. For instance, an electronics retailer would be unlikely to value search interest more than a few weeks or months old, as the user likely has made the purchase to which the search related. On the other hand, users who employ terms indicating that they are in a particular profession or occupation (e.g. lawyer, corporate purchasing agent) are providing information about user status that is less likely to change even over several years. Therefore, some strategies may look back over a greater interval.

In step 312, each cookie is assigned to a search strategy. This can be conducted in real time, so that as each search occurs, the results are analyzed, and an advertising strategy assigned.

Alternatively, the assignment of search strategies could be conducted at intervals, on a batch basis. For instance, daily, when the ASC's computers have surplus capacity due to reduced demand, all cookies having new searches during the past day are processed. The processing includes determining if the search terms associated with the cookie are a match for any of the strategies. Each strategy's search string may be used to search the database, and all cookies with hits are assigned that strategy.

Some cookies may have multiple list matches (“hits”) for several advertising strategies simultaneously. For each ad to be served, one of the matching strategies must be selected. A default tie breaker may be the recency of the search that generated the hits, although a single search may generate multiple hits. In some instances, the advertiser that more highly values the opportunity to reach that users is given priority, to maximize the advertising revenue for the publisher. For instance, an executive's search for “corporate jet fuel costs” might be a hit for both an airplane manufacturer and for an issuer of gas station credit cards. Undoubtedly, the airplane manufacturer would more highly value reaching the executive with its ads than would the credit card issuer. Other systematic or random means may be applied as well for assigning cookies with multiple hits to advertising strategies.

Other cookies may have no hits. As discussed above with respect to the first embodiment, these may receive no ads under this scheme. In such instances “receiving no ads” may mean no pop-ups or other unembedded ads are served. On the other hand, “no ads” may mean that no ads are served in a particular slot on a page, yet that ad may be filled by other means not flowing from the search term information. In this instance, the ad may revert to the publisher, who can place an ad for its own products or services. In other instances, the publisher may have arranged with another party for lower-value ads that are not directed to particular users, or which are directed by other means. Such ads may in fact be served by the ASC, but are selected based on things other than the search history of the user.

In step 314, an interval passes between the user receiving the search results (which may include advertisements on the result page based on the search terms used.) In step 316, the user visits a publisher's web page. The publisher has contracted with the ASC to serve advertisements, so the page includes an action tag that facilitates the ASC determining the user's cookie.

In step 320, the ASC searches the database to determine if the cookie exists. If so, then it determines the advertising strategy assigned to the cookie. In step 322, the ASC serves the advertisement of the selected strategy to the user, providing a high-value advertisement of substantial interest to the user, and of substantial value to the advertiser. If no cookie is found, or the cookie is not assigned to a specific advertising strategy, the ASC proceeds with one of the “no ad” approaches noted above which may include serving a non-targeted ad.

While the above is discussed in terms of preferred and alternative embodiments, the invention is not intended to be so limited.

1. A method of distributing Internet advertisements to users, each associated with a unique identifier, the method comprising:
providing an advertisement;
associating a web search term with the advertisement, such that users employing the term in a search are desired recipients of the advertisement;
collecting search terms employed by each user at a search facility;
in response to a user visiting a publisher web site, determining if the user has employed the search term; and
if the user has employed the search term, then serving the advertisement to the user.

2. The method of claim 1 including storing in a database the search terms used by each user in association with the unique identifiers of each user.

3. The method of claim 1 wherein determining if the user has employed the search term includes collecting the user's unique identifier in response to the user visiting the publisher web site, and querying the database for information about the search terms employed by the user.

4. The method of claim 1 including providing a plurality of advertisements, each having a different associated search term.

5. The method of claim 1 including providing a plurality of different databases, each containing a plurality of unique identifiers, and each database associated with a different advertisement.

6. A method of distributing Internet advertisements to users comprising:
collecting search terms employed by users of a search engine or search provider or its distribution partners web site(s);
based on the collected search terms, assigning each user to a selected advertising strategy; and
in response to a user visiting a publisher web site, enacting the selected advertising strategy.

7. The method of claim 6 wherein collecting search terms includes collecting a unique identifier associated with each user.

8. The method of claim 6 wherein collecting search terms includes collecting combinations of multiple search terms.

9. The method of claim 6 wherein assigning each user to an advertising strategy includes comparing a set of search terms associated with an advertisement, and if the user has employed any of the search terms, assigning the user to an advertising strategy that includes serving the advertisement to the user.

10. The method of claim 6 wherein assigning each user to an advertising strategy occurs before the user visits the publisher web site.

11. The method of claim 6 including providing a plurality of selected advertisements, each associated with a selected advertising strategy, and wherein at least one of the advertising strategies comprises a default strategy in which none of the selected advertisements are served.

12. The method of claim 11 wherein the default advertising strategy includes serving an advertisement other than the selected advertisements if the search terms do not relate to one of a collection of selected advertisements.

13. The method of claim 11 wherein enacting the advertising strategy includes serving no advertisement if the search terms do not relate to one of a collection of selected advertisements.

14. The method of claim 6 wherein assigning each user to an advertising strategy includes assigning at least some of the users to a strategy of serving no advertisement.

15. The method of claim 6 wherein enacting the selected advertising strategy includes serving the user an advertisement at a different time than providing search results in response to a search request.

16. A method of distributing Internet advertisements to users comprising:
collecting search terms employed by users of a search facility;
collecting a unique identifier associated with each user;
storing the search terms and unique identifiers in a database, with each identifier associated with the search terms employed by the associated user;
generating a plurality of selected advertising strategies, each with an associated desired search term;
assigning identifiers associated with one of the desired search terms to an associated one of the advertising strategies; and
in response to a user visiting a publisher web site, determining the user's unique identifier, searching the database to determine an assigned advertising strategy, and serving an advertisement to the user based on the strategy.

17. The method of claim 16 wherein collecting search terms includes collecting combinations of multiple search terms.

18. The method of claim 16 wherein assigning each user to an advertising strategy occurs before the user visits the publisher web site.

19. The method of claim 16 including providing a plurality of selected advertisements, each associated with a selected advertising strategy, and wherein at least one of the advertising strategies comprises a default strategy in which none of the selected advertisements are served.

20. The method of claim 19 wherein the default advertising strategy includes serving an advertisement other than the selected advertisements if the search terms do not relate to one of a collection of selected advertisements.
